(19) United States
(12) Patent Application Publication
(10) Pub. No.: US 2020/0331781 A1
(43) Pub. Date: Oct. 22, 2020

(54) FLUID TREATMENT PROCESS

(71) Applicant: CAPE PENINSULA UNIVERSITY OF TECHNOLOGY

(72) Inventors: Gunnar Lieb VISSER, Otjiwaronga (NA); Mahabubur Rahman CHOWDHURY, Cape Town (ZA); Veruscha Grizelda FESTER, Cape Town (ZA)

(73) Assignees: CAPE PENINSULA UNIVERSITY OF TECHNOLOGY, Cape Town (ZA); CAPE PENINSULA UNIVERSITY OF TECHNOLOGY, Cape Town (ZA)

(21) Appl. No.: 16/088,411

(22) PCT Filed: Jul. 12, 2017
(86) PCT No.: PCT/IB2017/054203

§ 371 Date: Sep. 25, 2018

(30) Foreign Application Priority Data
Jul. 12, 2016 (ZA) 2016/04800

(51) Int. Cl. C02F 1/72; C02F 1/78

(52) U.S. Cl. CPC C02F 1/722; C02F 2101/308; C02F 1/725; C02F 1/78

(57) ABSTRACT

This invention provides for a continuous process for treating a contaminated fluid. The process comprising introducing an oxidizing agent to the contaminated fluid feed, and contacting the contaminated fluid feed with an oxidizing agent activator, wherein the oxidizing agent activator is immobilized on a replaceable permeable reaction barrier.

THIS invention relates to a process for the continuous treatment of a contaminated fluid through the use of a replaceable permeable reaction barrier. In particular, but not exclusively, the invention relates to a process and for the continuous treatment of a contaminated fluid, including textile, petroleum refinery, or abattoir effluent.

### BACKGROUND

Contaminated liquid and gaseous effluents continue to be a major cause of concern among regulatory and health authorities. One such example is textile waste water.

Yearly about 80 000 tonnes of textile dyes are being produced which contribute to about 177 000 Megaliter of textile wastewater (Allègre et al., 2006). This wastewater is being treated by traditional methods such as biological treatment, chemical treatment (flocculation and adsorption), membrane filtration and advanced oxidation processes (AOPs). With the exception of AOPs, these methods have a relatively low efficiency and each suffer from additional setbacks such as the production of sludge, production of other undesirable retentates, prohibitively high cost, concerns relating to process maintenance, and others.

Advanced Oxidation Processes (AOPs) are becoming more popular in the treatment of contaminated liquids and gasses due to their high efficiency in mineralizing organic substances into CO₂ and H₂O. The processes rely on the production of highly oxidizing species such as hydroxyl radicals (OH.) and sulphate radicals (SO₄⁻.). The oxidizing species used in advanced oxidation processes may be generated heterogeneously or homogeneously.

When a catalytically active component is immobilized on a solid porous surface used in a chemical reaction to increase the reaction rate it is known as a heterogeneous catalyst. Heterogeneous catalysts have recently replaced a major portion of homogeneous catalyst in industry due to the increased pressure of environmental protection and economic feasibility.

Homogeneous catalysts cause major problems such as catalyst handling and storage, separation from reaction system, corrosion, toxicity, high cost and solid waste production. Heterogeneous catalysts have the major advantage over homogeneous catalysts of being easily separated from the reaction sample, recovered and regenerated for reuse. Immobilized catalysts provide the possibility for a process to be designed as a continuous system without the need to include a second process whereby the catalyst has to be removed from the bulk liquid sample. This in turn eliminates additional costs for the removal of the catalyst that would be present in a slurry system.

Muhammad et al. (2013) and Liang et al. (2012) made use of a zeolite supported and manganese oxide supported cobalt oxide respectively to treat phenol in a 500 ml slurry system with the result of degrading 100% phenol in three hours and 100 minutes respectively. Shi et al. (2012) and Shi et al. (2014) supported cobalt oxide with graphene oxide and treated Orange II dye using a 250 ml slurry system. They obtained 100% Orange II degradation in 6 minutes and 4 minutes respectively using a heterogeneous catalyst. Yang et al. (2007) made use of a one litre slurry system to treat 2,4-Dichlorophenol with a TiO₂/Co₃O₄ catalyst. Chowdhury et al. (2015) made use of Co₃O₄ to treat methyl orange with oxone as a peroxymonosulfate source, but also made use of a heterogeneous and homogeneous slurry system.

Biological treatment processes replicate, artificially or naturally the natural process by which water would re-establish its natural form after pollution has occurred (Allègre et al., 2006). Biological treatment methods are simple and cheap but do have the disadvantage that the traditional microorganisms are not able to easily degrade organic pollutants in textile and that microorganism toxic substances in textile effluent need to be removed by using adsorbents such as activated carbon.

Coagulation or flocculation is another process used to treat textile effluent. It is used to remove insoluble dyes and organic substances but cannot remove soluble dyes. Large amounts of sludge are formed during the flocculation process and no feasible methods have yet been developed to treat the sludge.

Adsorption on activated carbon is a process that can only be effectively done by pre-treating with flocculation or biological processes. A slight colour change is obtained by the combination of the processes but the cost of activated carbon remains high making the adsorption process a non-feasible option for textile effluent treatment.

The electrochemical treatment process is considered an advanced oxidation process by circulating wastewater in an electrolytic cell fitted with iron electrodes and oxidizing the dye with the hypochlorite ion formed in the process. Electrochemical treatment has the ability to treat larger volumes of water but forms iron hydroxide sludge which limits its use.

Ozonation is a process widely used in conjunction with UV irradiation and hydrogen peroxide-ozone processes to treat textile effluents by producing non-selective hydroxyl radicals (OH.) which oxidize organic material such as textile dyes. Ozonation causes decolourization of the dye but does not cause a significant decrease in the chemical oxygen demand (COD). In addition, the process is expensive due to the high cost of ozone and the installation costs associated with the process.

In the past membrane separation followed the production process, in a separate process, but these days are widely used in continuous water treatment circuits built into the production process. Membrane processes reduce colour content as well as COD and biochemical oxygen demand (BOD) in wastewater. Different membrane process such as microfiltration (MF), ultrafiltration (UF), nanofiltration (NF) and reverse osmosis (RO) are chosen according to the desired product. However, these methods also suffer from disadvantages such as high pressure, resulting brine solution, and insufficient quality of treated water.

There is therefore a need for a contaminated fluid treatment process that addresses at least some of the shortcomings of the prior art.

### SUMMARY OF THE INVENTION

According to a first aspect of the present invention there is provided a continuous process for treating a contaminated fluid, the process comprising the steps of:
providing a flow of contaminated fluid feed comprising at least one organic contaminant,
introducing an oxidizing agent to the contaminated fluid feed, and
contacting the contaminated fluid feed with an oxidizing agent activator to provide a treated fluid stream,

wherein the oxidizing agent activator is deposited, immobilized, or loaded in or onto a replaceable permeable reaction barrier.

In one embodiment, the contaminated fluid feed is pumped to the permeable reaction barrier at a flow rate of at least 40 ml/min.

In one embodiment, the oxidizing agent is a source of hydroxyl radicals, sulfate radicals, or both hydroxyl radicals and sulfate radicals.

In a preferred embodiment, the oxidizing agent is selected from the group consisting of ozone, hydrogen peroxide, and peroxymonosulfate.

Preferably, the oxidizing agent is peroxymonosulfate.

In one embodiment, the oxidizing agent activator is a transition metal compound selected from the group consisting of Co (II), Ru (III), Fe (II), Fe (III), Ce (III), Mn (II), Ni (II), and combinations thereof.

Preferably, the oxidizing agent activator is a Co (II) compound.

Preferably, the Co (II) compound is Co₃O₄.

In one embodiment, the oxidizing agent activator is deposited, immobilized, or loaded in or onto the permeable reaction barrier at a loading of at least about 1 mg/cm².

In a preferred embodiment, the oxidizing agent activator is deposited, immobilized, or loaded in or onto the permeable reaction barrier at a loading of about 10.0 mg/cm² to about 40 mg/cm².

In one embodiment, the continuous process provides for a number of replaceable permeable reaction barriers, such that when in use, each reaction barrier can be independently isolated and replaced without stopping the process.

In one embodiment, the contaminated fluid feed is an effluent feed in a textile, petroleum, or abattoir process.

### BRIEF DESCRIPTION OF THE DRAWINGS

The invention will now be described in more detail with reference to the following non-limiting embodiments and figures in which:

FIG. 1 shows a schematic representation of one embodiment of the process according to the present invention;

FIG. 2 shows a sectioned side view of a portion of the apparatus including a removable permeable reaction barrier module;

FIG. 3 shows degradation curves for methyl orange (initial MO concentration of 10 mg/L) using the method of the present invention;

FIG. 4 shows degradation curves for black dye at various peroxymonosulfate concentrations with a cobalt oxide load of 0.0329 g/cm²;

FIG. 5 shows degradation curves for black dye at a with a peroxymonosulfate concentration of 3 g/L with a zinc oxide load of 0.0165 g/cm²;

FIG. 6 shows the degradation curves for blue dye with a cobalt oxide load of 0.0247 g/cm²;

FIG. 7 shows a graphical representation of COD removal in a petroleum refinery feed at various peroxymonosulfate concentrations with a Co₃O₄ loading of 0.0247 g/cm²;

FIG. 8 shows a graphical representation of the performance of the method of the invention in the reduction in phenol content in a petroleum refinery effluent;

FIG. 9 shows a graphical representation of the COD removal achieved for a poultry abattoir effluent at various peroxymonosulfate concentrations with a Co₃O₄ loading of 0.0247 g/cm²; and

FIG. 10 shows degradation curves in a comparative example for methyl orange feed and a textile effluent feed using a Fenton reaction using the system parameters of the present invention.

### DETAILED DESCRIPTION OF A PREFERRED EMBODIMENT

The present invention will now be described more fully hereinafter with reference to the accompanying figures, in which some of the non-limiting embodiments of the invention are shown.

The invention as described hereinafter should not be construed to be limited to the specific embodiments disclosed, with slight modifications and other embodiments intended to be included within the scope of the invention.

Although specific terms are employed herein, they are used in a generic and descriptive sense only and not for purposes of limitation.

As used herein, throughout this specification and in the claims which follow, the singular forms “a”, “an” and “the” include the plural form, unless the context clearly indicates otherwise.

The terminology and phraseology used herein is for the purpose of description and should not be regarded as limiting. The use of the terms “comprising”, “containing”, “having”, “including”, and variations thereof used herein, are meant to encompass the items listed thereafter, and equivalents thereof as well as additional items.

The present invention provides for a process and an apparatus for the continuous treatment of a contaminated fluid through the use of a replaceable permeable reaction barrier.

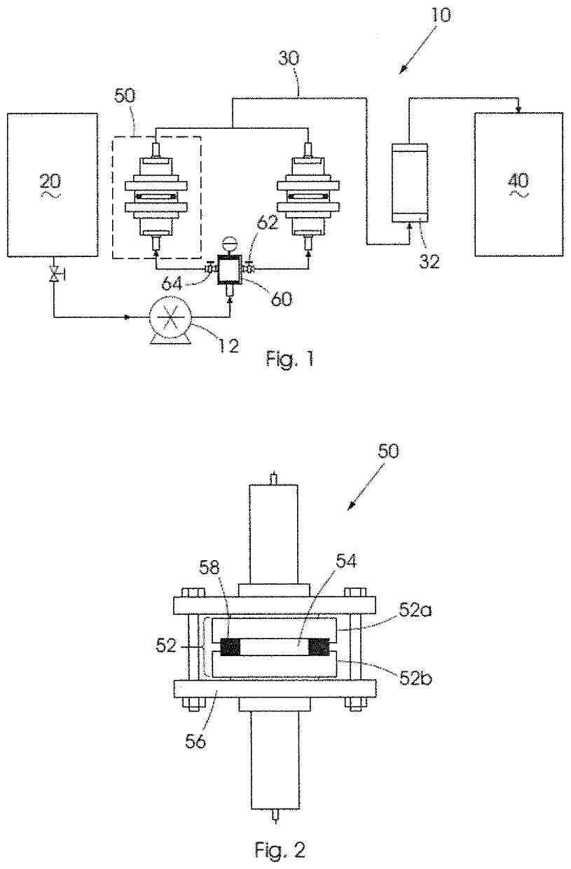

With reference to FIG. 1, the present invention provides an apparatus 10 for treating a feedstock fluid which may be provided from a source feed tank 20. The apparatus 10 further comprises a pump 12 for providing a continuous flow of a feedstock fluid, which in this example is contained in the source feed tank 20.

The feedstock fluid may be a contaminated feed which contains at least one organic contaminant. Further, it should be understood that the contaminated fluid feed may either be in the gaseous or liquid form.

The apparatus 10 provides for a continuous flow of the feedstock fluid feed through a reactor zone, comprising one or more reaction barrier modules 50. As can be seen in FIG. 2, the reactor barrier module 50 comprises at least one removable permeable reaction barrier module 52, which is suitable for receiving and securing the permeable reaction barrier 54.

In the example shown in FIG. 2, the removable permeable reaction barrier module 52 comprise complementary annular retaining members 52a and 52b which is adapted for receiving and securing the reaction barrier in place when the reaction is in progress.

Further, in the example shown in FIG. 2, each of the annular retaining members 52a and 52b comprises a recessed surface 58 on the inner surface thereof for seating against the reaction barrier 54 and locating it in the optimal reaction position.

It will be appreciated by those skilled in the art that the retaining members 52a and 52b may have complementary engagement formations acting in addition to, or as an alternative to, the recessed surface 58 for locating and securing the reaction barrier in position, such as complimentary teeth formations, complementary protrusions and depressions, or the like.

The annular retaining members 52a and 52b may be secured in position through a lock-and-release type mechanism 56 which allows for the retaining members to be held in position with sufficient force to keep the reaction barrier 54 in position for the duration of the reaction, or until the lock-and-release mechanism is released to allow for the replacement of the reaction barrier. The flange plate lock-and-release type mechanism 56 shown in FIG. 2 may be secured together by conventional fastening means such as bolt and nut variations, or through custom retaining clip type formations (not shown) that would facilitate easy replacement of the reaction barrier.

The apparatus 10 may be used, for example, in a continuous process for treating contaminated fluid which comprises at least one organic contaminant.

The process comprises the step of introducing an oxidizing agent to the contaminated fluid feed. The mechanism for the introduction of the oxidizing agent is not specifically indicated in FIG. 1, and it should be understood that the oxidizing agent can be added to the feed tank 20, or that the oxidizing agent can be provided as a separately controlled continuous flow into the system, prior to the contact with the oxidizing agent activator or other catalyst which is immobilized on the permeable reaction barrier 54.

The contaminated fluid feed including the oxidizing agent is brought into contact with the oxidizing agent activator to provide a treated fluid stream 30. The treated fluid stream 30 may be treated in a further step, such an activated carbon treatment step 32, prior to being collected in a product holding tank 40, recirculated for treatment to the feed tank 20, or being redistributed for further use elsewhere in the facility where the apparatus is installed.

The oxidizing agent activator used in the process is immobilized on the replaceable permeable reaction barrier 54. The oxidizing agent activator immobilized on the permeable reaction barrier may be a transition metal compound selected from the group consisting of Co (II), Ru (III), Fe (II), Fe (III), Ce (III), Mn (II), Ni (II), and combinations thereof.

In a particularly preferred embodiment of the invention the oxidizing agent activator is the Co (II) compound Co₃O₄. The particles described in Chowdhury et al., RSC Adv., 2015, 5, 104991, which is incorporated herein by reference, have proven to be particularly efficient.

The oxidizing agent activator may be suspended in water and passed through a Buchner type funnel with the permeable reaction barrier material acting as the filter, thereby providing a uniform distribution of the catalyst material in the porous reaction barrier material by recycling the filtrate until it has been determined that the desired concentration of catalyst material has been applied to the permeable material. However, the oxidizing agent activator may be deposited, immobilized, or loaded onto the permeable reaction barrier material according to any method known in the art that will achieve a desirable catalyst loading.

The oxidizing agent activator may be deposited, immobilized, or loaded in or onto the permeable reaction barrier material at a loading of at least about 0.01 mg/cm², at least about 0.1 mg/cm², at least about 1.0 mg/cm², or at least about 100 mg/cm². Preferably, the oxidizing agent activator may be deposited, immobilized, or loaded in or onto the permeable reaction barrier material at a loading of between about 1.0 mg/cm² to about 100 mg/cm², preferably between about 2.0 mg/cm² to about 80 mg/cm², preferably between about 5.0 mg/cm² to about 60 mg/cm², preferably between about 10.0 mg/cm² to about 40 mg/cm², even more preferably between about 15.0 mg/cm² to about 30 mg/cm².

Flow rate, catalyst contact time, or reaction time is an important parameter in any effluent treatment process. In a continuous flow process, the rate of flow at which the process can operate may be limited by several factors, including the time required for contact with the reagents, chemicals, or catalysts. A high flow rate, and a subsequent high breakdown rate of organic contaminants, is highly desirable in an industrial process for reasons that require no further elaboration. The inventors of the present invention have surprisingly found that the effluent feed can be pumped to the permeable reaction barrier at flow rates of more than 20 ml/min, more than 30 ml/min, more than 40 ml/min, more than 100 ml/min, and more than 200 ml/min without losing chemical breakdown efficiency.

It will be appreciated by those persons skilled in the art that the apparatus and process of the present invention may be modular in the sense that a single feedstock feed may be split by a manifold 60, and channelled to a number of removable reaction barrier modules in the reaction zone. In use, each removable reaction barrier module 50 may then be isolated by closing the particular line through the use of valves 62, 64 to enable the module 52 to be removed and the permeable reaction barrier 54 to be replaced without stopping the process. The particular line may then be switched on once the module is returned to its original position.

Further, it is envisaged that additional modular elements may be added to the apparatus including, for example, additional effluent polishing columns, in-line real-time analysis, and an electronic monitoring and control system.

### EXAMPLE 1

### Model Dye Wastewater

Methyl orange (MO) was selected as a model dye in Example 1 due to its popularity in textile wastewater degradation studies.

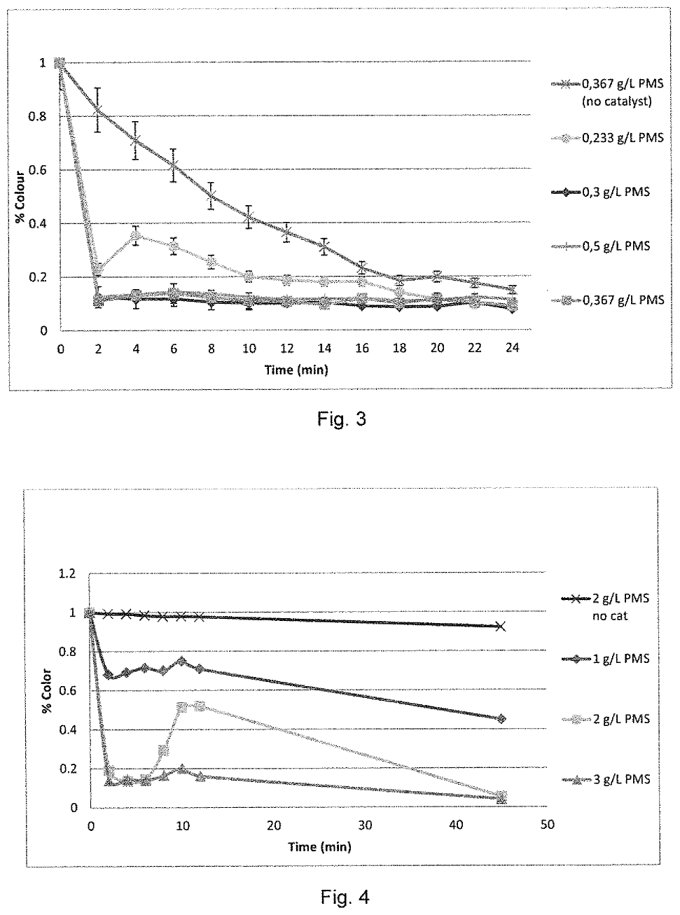

A number of studies were done to determine the optimum operating parameters for the most efficient breakdown of the dye. The graphical representation shown in FIG. 3 represents the degradation curves for the most efficient breakdown of the methyl orange dye based on the optimization experiments.

FIG. 3 shows degradation curves for methyl orange, with an initial MO concentration of 10 mg/L. The optimum parameters were determined to be a catalyst, or oxidizing agent activator, load of 0.0247 g/cm² (0.3 g catalyst per PRB) with peroxymonosulfate concentration as the oxidizing agent at a concentration of 0.367 g/L.

The system was operated at a flow rate of 40 ml/min. At these conditions, a maximum degradation of 88.8% was achieved, with the final product feed containing less than 0.5 mg/L MO after 12 minutes.

The MO feed was pumped through the system in 12 minutes, after which it was allowed to stand until 45 minutes passed when the final sample was taken. The effluent feed, comprising the oxidizing agent, is pumped to the permeable reaction barrier, comprising the oxidizing agent activator, at a flow rate of 40 ml/min, after which the homogeneous reaction to continues after contact with the oxidizing agent activator. The 12 minute sample is representative of the heterogeneous catalysis process.

### EXAMPLE 2a

### Black Dye Drop Textile Effluent, Co₃O₄/Peroxymonosulfate

An industrial black dye drop waste feed was diluted 1:20, dye effluent to water, due to the dilution of the 0.5 m³ effluent in a 20 m³ sump that would occur in the plant from which the effluent was obtained.

FIG. 4 shows degradation curves for black dye at various PMS concentrations (oxidizing agent) and a 0.0329 g/cm² load of cobalt oxide catalyst (oxidizing agent activator) at 40 ml/min.

From FIG. 4 it can be seen that oxidizing agent concentrations of 3 g/L PMS and 2 g/L PMS resulted in the same degradation efficiency after 45 minutes of reaction. The oxidizing agent activator load used in the permeable reaction barrier was increased to 0.0329 g/cm² and the optimum PMS (oxidizing agent) concentration was 2 g/L. At these conditions, the maximum degradation was 94.6% after 12 minutes.

### EXAMPLE 2b

### Black Dye Drop Textile Effluent, ZnO/Peroxymonosulfate

In another embodiment of the invention, Zinc oxide (ZnO) was used as a catalyst, or oxidizing agent activator, in conjunction with peroxymonosulfate (Oxone) as an oxidizing agent.

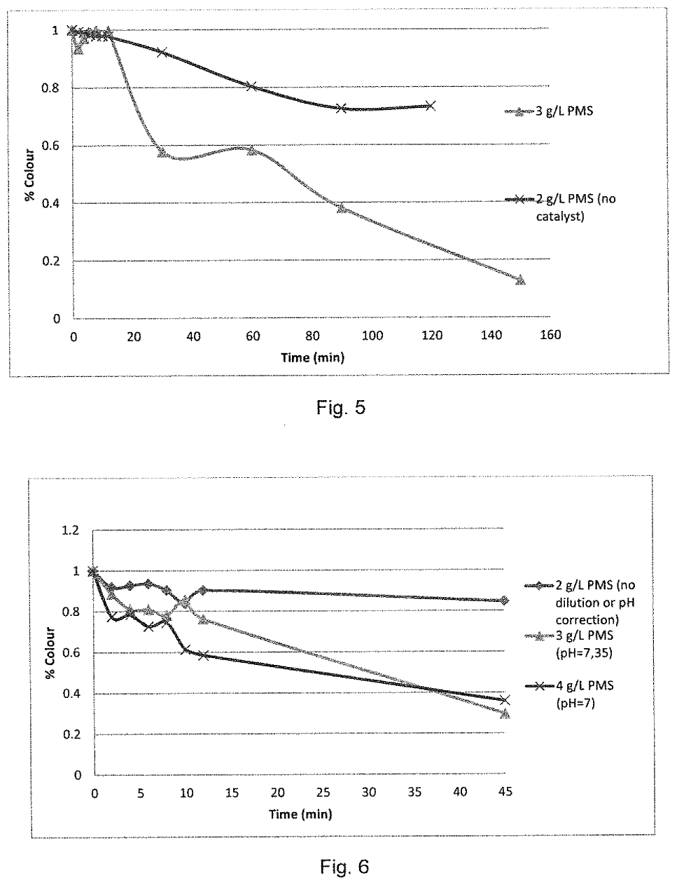

FIG. 5 shows the degradation curve of the black effluent with a permeable reaction barrier loaded with 0.0165 g/cm² ZnO catalyst, and oxidizing agent concentration of 3 g/L PMS in the feed at 40 ml/min. The rate of degradation was less rapid compared to that seen in Example 2a, however an 87.3% degradation was achieved over a period of 150 minutes. FIG. 5 also shows the rate of degradation and total degradation achieved by PMS in the absence of any catalyst (23%).

### EXAMPLE 3

### Blue Dye Drop Textile Effluent, Co₃O₄/Peroxymonosulfate

In another experiment, the method of the presented invention was tested against an industrial blue dye drop waste feed. The initial colour of the solution was not as concentrated as the black dye; however the feed had a relatively strong organic strength. Due to the lightness of the colour and the sensitivity of the colorimeter, no dilution could be done.

FIG. 6 shows the degradation curves for a 0.0247 g/cm² loading of cobalt oxide catalyst at various concentrations and pH values of the undiluted feed solution.

The pH of the initial solution was measured to be 11, which was determined to be outside the optimum operating range for the cobalt oxide and PMS reaction system. A pH adjustment was done for the oxidizing agent concentration experiments at 3 g/L PMS and 4 g/L PMS, and the degradation of the dye was successful. At 3 g/L PMS, a maximum degradation of 70.5% was achieved after a degradation time of 45 minutes at 40 ml/min after 12 minutes.

### EXAMPLE 4

### Petroleum Refinery Effluent, Co₃O₄/Peroxymonosulfate

In another experiment, the method of the present invention was tested with an industrial effluent obtained from a petroleum refinery plant. The results were analysed at an independent laboratory (BemLab) to determine the efficiency of the degradation process. The measure of efficiency was determined by the degradation of chemical oxygen demand (COD) and total phenol concentration in the wastewater feed.

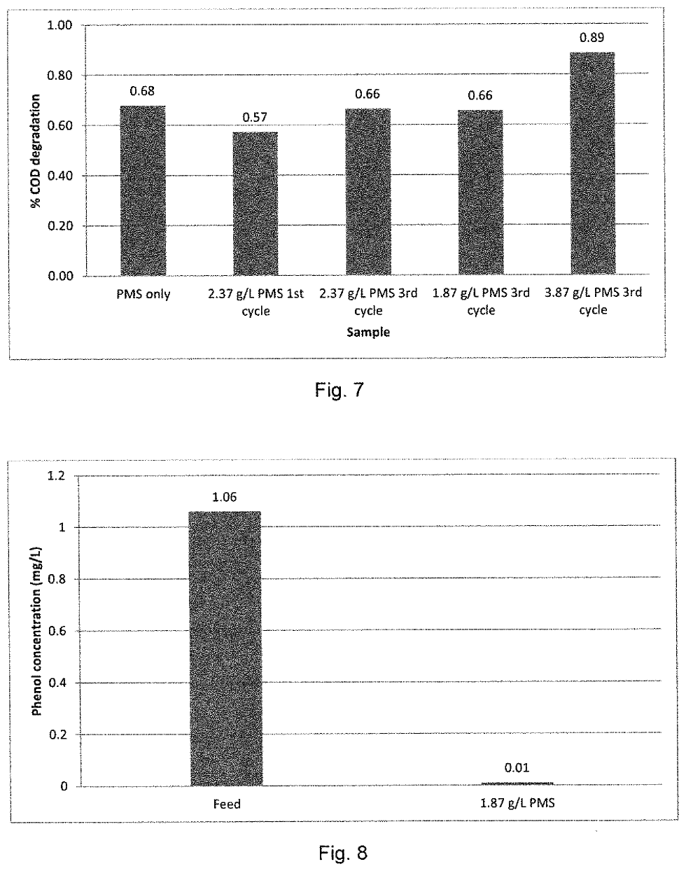

FIG. 7 shows a graphical representation of the COD removal achieved by the method of the present invention at the various concentrations of oxidizing agent (PMS), with a constant oxidizing agent activator (Co₃O₄) loading of 0.0247 g/cm². As can be seen from the results presented in FIG. 7, it was necessary to cycle the wastewater feed through the single reaction barrier system 3 times to obtain a >65% degradation efficiency in respect of COD. The most efficient degradation occurred at an oxidizing agent (PMS) concentration of 3.87 g/L with an oxidizing agent activator concentration of 0.0247 g/cm² (0.3 g). The maximum degradation of COD was 89%. FIG. 8 shows a graphical representation of the efficiency of the method for the reduction in phenol content in a petroleum refinery effluent.

Table 1 shows the chemical analysis obtained for the various samples (feed and treated samples) at different reaction conditions.

TABLE 1
Chemical analysis of petroleum refinery effluent at
0.0247 g/cm² Co₃O₄ and various concentrations of PMS

| | | COD | | | | | | | free | |
|---|---|---|---|---|---|---|---|---|---|---|
| | COD | breakdown | EC | SO₄⁻ | NH₃ | Co²⁺ | | TSS | Cl⁻ | Phenol |
| Sample | (mg/L) | (%) | (mS/m) | (mg/L) | (mg/L) | (μg/L) | NTU | (mg/L) | (mg/L) | (mg/L) |
| Feed | 131 | | 200 | 464 | 4.83 | 1 | 1.19 | 32 | 0.35 | 1.06 |
| 2.37 g/L | 42 | 68 | 384 | 2145 | <0.28 | 20.2 | 1.77 | 54 | 66 | |
| Oxone | | | | | | | | | | |
| only | | | | | | | | | | |
| 2.37 g/L | 56 | 57 | 398 | 2085 | <0.28 | 344.4 | 0.08 | 44 | 59 | |
| Oxone | | | | | | | | | | |
| 1^{st} cycle | | | | | | | | | | |
| 2.37 g/L | 44 | 66 | 545 | 2137 | <0.28 | 656.9 | 0 | 37 | 65 | |
| Oxone | | | | | | | | | | |
| 3^{rd} cycle | | | | | | | | | | |
| 1.87 g/L | 45 | 66 | 475 | 1827 | <0.28 | 99.5 | 0 | 32 | 34 | 0.01 |
| Oxone | | | | | | | | | | |
| 3^{rd} cycle | | | | | | | | | | |
| 3.87 g/L | 15 | 89 | 749 | 3113 | <0.28 | 943.6 | 0.34 | 59 | 151 | |
| Oxone | | | | | | | | | | |
| 3^{rd} cycle | | | | | | | | | | |

### EXAMPLE 5

### Poultry Abattoir Effluent, Co₃O₄/Peroxymonosulfate

In another experiment, the method of the present invention was tested with an industrial effluent obtained, from a poultry abattoir. The effluent was raw and no pre-treatment or filtration was done prior to treatment with the method of the present invention. After the treatment, the product samples as well as the feed sample was analysed by an independent laboratory.

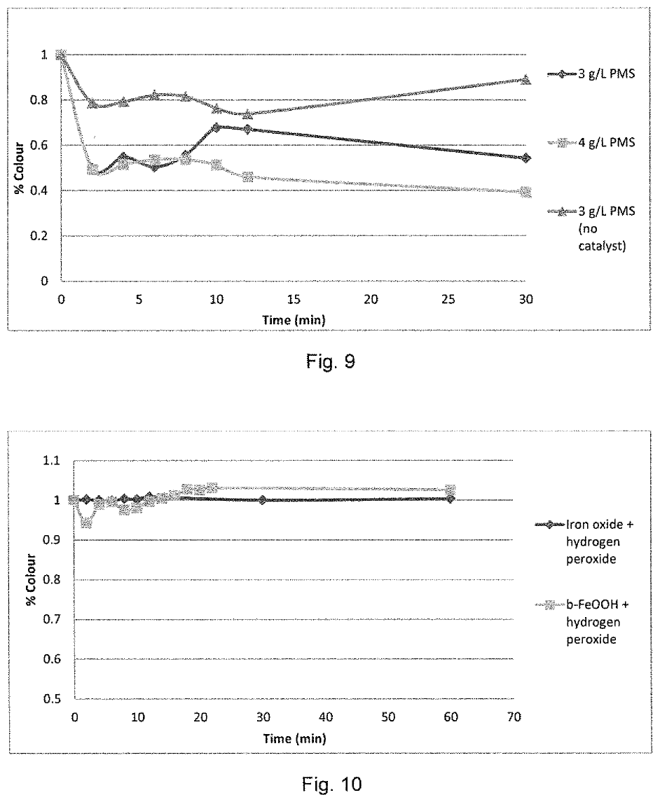

The process was successful using the cobalt oxide oxidizing agent activator at a load of 0.0247 g/cm² in combination with PMS as the oxidizing agent. A maximum COD removal of 73% was achieved, corresponding to a 2425 mg/L breakdown of COD. FIG. 9 shows a graphical representation of the COD removal achieved for the poultry waste feed at the various concentrations of oxidizing agent, with a constant oxidizing agent activator (Co₃O₄) loading of 0.0247 g/cm².

As can be seen from FIG. 9, the presence of oxidizing agent activator increases the colour change by 35% at an oxidizing agent concentration of 3 g/L PMS, and by 50% at a concentration of 4 g/L PMS. The 1 g/L increase in PMS (from 3 g/L to 4 g/L) increased the colour change by 15%. The turbidity is also decreased by 85% at a 4 g/L PMS concentration and by 40% for a 3 g/L PMS concentration.

Table 2 below represents the chemical analysis done on the waste feed and treated poultry effluent. The sulfate and chlorine concentration is increased as the PMS concentration is increased.

TABLE 2
Chemical analysis of poultry effluent at 0.0247
g/cm² Co₃O₄ and various concentrations of PMS

| | | COD | | | | |
|---|---|---|---|---|---|---|
| | COD | breakdown | SO₄⁻ | Co²⁺ | Turbidity | Cl⁻ |
| Sample | (mg/L) | (%) | (mg/L) | (μg/L) | (NTU) | (free mg/L) |
| Feed | 4200 | | 464 | 7.6 | 395 | 259.9 |
| 3 g/L PMS | 3140 | 25 | 2145 | 8.7 | 494 | 237.5 |
| (no catalyst) | | | | | | |
| 3 g/L PMS + 0.3 | 1775 | 58 | 2085 | 1366.6 | 237 | 146.1 |
| g catalyst | | | | | | |
| 4 g/L PMS + 0.3 | 1120 | 73 | 2137 | 1678.3 | 61 | 221 |
| g catalyst | | | | | | |

### COMPARATIVE EXAMPLE A

### Model Dye and Textile Effluent

The reaction between iron and hydrogen peroxide is known as the Fenton's reaction and is a well-known method for the breakdown of organic dye contaminants.

Iron oxide (Fe₂O₃) and iron oxyhydroxide (β-FeOOH) was utilized as the oxidizing agent activator in combination with hydrogen peroxide as the oxidizing agent in a reactor setup similar to that used in the above described experiments. The degradation curve is represented below. A catalyst loading of 0.0247 g/cm² was used with 20 ml of 30% hydrogen peroxide at 40 ml/min.

For the iron oxyhydroxide catalyst the methyl orange model dye was used and for the iron oxide, the industrial textile plant effluent was used. As can be seen from the FIG. 10, the utilization of Fenton's reaction was ineffective compared to the method of the present invention. No degradation of the effluent occurred. One possible explanation for these results is that the reaction between the iron source and the hydrogen peroxide is not as rapid enough at the specific system parameters to produce the hydroxyl radicals required for the degradation of the dye.

This above description of some of the illustrative embodiments of the invention is to indicate how the invention can be made and carried out. Those of ordinary skill in the art will know that various details may be modified thereby arriving at further embodiments, but that many of these embodiments will remain within the scope of the invention.

1. A continuous process for treating a contaminated fluid, the process comprising the steps of:
providing a flow of contaminated fluid feed comprising at least one organic contaminant,
introducing an oxidizing agent to the contaminated fluid feed, and
contacting the contaminated fluid feed with an oxidizing agent activator immobilized onto a replaceable permeable reaction barrier, which permeable reaction barrier is positioned in the flow path of the contaminated fluid feed, by passing the contaminated fluid feed through the permeable reaction barrier comprising the oxidizing agent activator,
thereby to continuously to provide a treated fluid stream.

2. A continuous process according to claim 1, wherein the contaminated fluid feed is pumped to the permeable reaction barrier at a flow rate of at least 40 ml/min.

3. A continuous process according to claim 1, wherein the oxidizing agent is a source of hydroxyl radicals, sulfate radicals, or both hydroxyl radicals and sulfate radicals.

4. A continuous process according to claim 3, wherein the oxidizing agent is selected from the group consisting of ozone, hydrogen peroxide, and peroxymonosulfate.

5. A continuous process according to claim 4, wherein the oxidizing agent is peroxymonosulfate.

6. A continuous process according to claim 1, wherein the oxidizing agent activator is a transition metal compound selected from the group consisting of Co (II), Ru (III), Fe (II), Fe (III), Ce (III), Mn (II), Ni (II), and combinations thereof.

7. A continuous process according to claim 6, wherein the oxidizing agent activator is a Co (II) compound.

8. A continuous process according to claim 7, wherein the Co (II) compound is Co₃O₄.

9. A continuous process according to claim 1, wherein the oxidizing agent activator is deposited, immobilized, or loaded in or onto the permeable reaction barrier at a loading of at least about 1 mg/cm².

10. A continuous process according to claim 9, wherein the oxidizing agent activator is deposited, immobilized, or loaded in or onto the permeable reaction barrier at a loading of about 10.0 mg/cm² to about 40 mg/cm².

11. A continuous process according to claim 1, wherein the process provides for a number of replaceable permeable reaction barriers, such that when in use, each reaction barrier can be independently isolated and replaced without stopping the process.

12. A continuous process according to claim 1, wherein the contaminated fluid feed is an effluent feed in a textile, petroleum, or abattoir process.
